(19) United States
(12) Patent Application Publication
(10) Pub. No.: US 2025/0158470 A1
(43) Pub. Date: May 15, 2025

(54) STATOR FOR AN ELECTRIC MACHINE WITH CLAMPINGLY FIXED WIRE END PORTIONS AND ELECTRIC MACHINE WITH THE STATOR

(71) Applicant: ZF Friedrichshafen AG, Friedrichshafen (DE)

(72) Inventors: Tobias SCHRENK, Bad Neustadt an der Saale (DE); Valentin GÖPFERT, Werneck (DE); Sebastian REIM, Schweinfurt (DE); Markus WINKLER, Königsberg (DE)

(21) Appl. No.: 18/936,266

(22) Filed: Nov. 4, 2024

(30) Foreign Application Priority Data
Nov. 10, 2023 (DE) 10 2023 211 133.0

(51) Int. Cl. H02K 3/28; H02K 1/16; H02K 3/50

(52) U.S. Cl. CPC H02K 3/28; H02K 1/16; H02K 3/50; H02K 2203/09

(57) ABSTRACT

A stator having a stator body with radially oriented individual teeth, a polyphase stator winding with tooth coils, a single tooth coil is arranged at an individual tooth, winding bodies have a winding area for the tooth coil formed by a base and two limit portions, a connector ring arrangement interconnects the tooth coils, the connector ring arrangement has a supporting portion to support the limit portions, and the connector ring arrangement has winding terminal tabs for connection of the tooth coils, at least one wire end portion is joined to an associated winding terminal tab. The wire end portions are fixed in each between a limit portions a supporting portion at a clamping location to shorten a free wire length of the wire end portion.

### BACKGROUND OF THE INVENTION

### 1. Field of the Invention

The disclosure is directed to a stator for an electric machine and to an electric machine with the stator.

### 2. Description of Related Art

Stators for electric machines with radially oriented stator teeth are known, in which the stator winding is formed by individual stator coils, also known as single tooth coils, which are wound around the stator teeth. The stator coils have two coil ends in each instance which are interconnected in a predetermined manner via an interconnection unit. To this end, the interconnection unit has, respectively, for every single tooth coil a terminal tab via which the two single tooth coils are welded on.

DE 10 2019 218 442 A1 discloses a stator of an electric machine with an annular lamination stack which is formed around a central axis and at which stator coils with coil ends are arranged by winding bodies, and with an interconnection device having a plurality of mutually insulated connection leads which have coil terminal areas for interconnecting the stator coils. The interconnection device is joined to the stator coils in an axial joining direction and is arranged adjacent to the stator coils and secured to the winding bodies by axial connector to form a plurality of axial connections. The interconnection device has radial supports for cooperating with the winding bodies which are formed independently from the axial connectors.

### SUMMARY OF THE INVENTION

An object of one aspect of the invention is to provide a stator of the type mentioned in the introductory part which is characterized by a high operational reliability.

The subject matter of one aspect of the invention is a stator that is formed and/or suitable for an electric machine. In particular, the electric machine is formed as an inrunner, a rotor being arranged radially inward of the stator. Alternatively, the electric machine can also be formed as an outrunner, wherein a rotor is arranged radially outward of the stator.

The stator has a stator body, which is formed around a main axis and which has a plurality of radially oriented individual teeth. In principle, the stator body can be formed of a plurality of identical segments, each of which has at least one, or exactly one, of the individual teeth. The individual segments are preferably connected to one another in such a way that they form a stator, in particular an annular and/or cylindrical stator. Alternatively, the stator body has an annular stator yoke at which the individual teeth are formed. For example, the stator body can be formed as a lamination stack.

The stator has a polyphase stator winding which has a plurality of single tooth coils formed from a winding wire, a single tooth coil being arranged in each instance at one of the individual teeth. In other words, the stator winding is formed as a concentrated winding in the form of single tooth coils. In particular, the individual teeth are wrapped in each instance individually by a winding wire. The winding wire is formed as a round wire, for example.

The stator has a plurality of winding bodies. The winding bodies have, in each instance, a winding area for the single tooth coil or winding wire, respectively. The winding area is formed by a base portion contacting one of the individual teeth by its front side and two limit portions which radially limit the winding area and are connected to the base portion. The stator preferably has two winding bodies for each individual tooth. The two winding bodies are arranged on opposite front sides of the individual teeth. The winding wire is wrapped around the respective individual tooth in each instance via the at least one winding body, preferably the two winding bodies, inside of the winding areas and secured against slippage. In particular, a front-side winding head of the single tooth coils is arranged in the winding area of the winding bodies or formed by the latter. For example, the winding bodies are formed from a heat-resistant and/or electrically insulating plastic.

Further, the stator has a connector ring arrangement, which is formed and/or suitable for interconnecting the single tooth coils. The connector ring arrangement is secured to a plurality of winding bodies at an axial front side of the stator. The single tooth coils are connected to one another via the connector ring arrangement, for example, in a delta connection or star connection. The connector ring arrangement preferably has a power connection via which the electric machine is connectable to power electronics. The connector ring arrangement is preferably arranged coaxially and/or concentrically at the stator so as to be joined to the stator coils in an axial joining direction and adjacent to the single tooth coils, preferably the winding heads. In a particularly preferable manner, the connector ring arrangement is secured to a plurality of the winding bodies via a plurality of axial connections.

The connector ring arrangement has at least one, or exactly one, supporting portion which faces the winding areas and via which the connector ring arrangement is supported and/or supportable at at least one, or exactly one, of the limit portions in radial direction with respect to the main axis to form a radial connection. In particular, the supporting portion serves to center and secure the connector ring arrangement in a defined radial position. The radial connection is preferably produced by a positive engagement in radial direction. The supporting portion can be effective radially on one side or radially on both sides. To this end, the supporting portion can engage at one or both of the limit portions of a winding body in each instance radially inwardly and/or radially outwardly. In a particularly preferable manner, the supporting portions are supported and/or supportable radially inward of the winding area at one of the limit portions. For example, the supporting portion can be formed in each instance as a circumferentially continuous or interrupted web.

The connector ring arrangement has a plurality of winding terminal tabs which are formed and/or suitable for the connection of the single tooth coils. In particular, at least one, or exactly one, winding terminal tab is associated with each single tooth coil. The winding terminal tabs are preferably arranged at a radial outer side of the connector ring arrangement. Alternatively, the winding terminal tabs can also be arranged at a radial inner side of the connector ring arrangement. For example, the winding terminal tabs are formed in each instance as terminal tabs which are angled in axial direction and/or aligned.

The winding wires of the single tooth coils have, in each instance, at least one, or exactly one, preferably exactly two, wire end portions which are bondingly joined at their ends by a free wire end to the associated winding terminal tab at a joining location. In particular, the at least one, preferably the two, wire end portions is/are arranged laterally or on both sides of a winding terminal tab. In other words, a winding terminal tab is arranged in each instance between two wire end portions or free wire ends thereof in circumferential direction. For example, the free wire ends can be welded or soldered to the respective winding terminal tab. In particular, a geometry of the winding terminal tab can be provided with a widening toward the joining location in order to eliminate or at least reduce a joint gap at the joining location between the wire end portion and winding terminal tab.

Within the framework of one aspect of the invention, the wire end portions are clampingly fixed in each instance between one of the limit portions and the respective supporting portion at a clamping location in each instance in order to shorten a free wire length of the wire end portion. The clamping location is preferably arranged radially outward when the winding terminal tabs are arranged at the radial outer side and radially inward when the winding terminal tabs are arranged at the radial inner side. In other words, the clamping is carried out electively between the radially outer limit portion and the supporting portion or between the radially inward limit portion and the supporting portion. The wire end portion is preferably acted upon by a clamping force in axial direction with respect to the axis of rotation. For example, the clamping force can be applied and maintained during production of the axial connection.

One aspect of the invention is based on the insight that the connector ring arrangement is excited to vibrate during operation of the electric machine and/or during operation of a vehicle outfitted with the electric machine, for example, a hybrid vehicle, due to the direct connection to the stator. The cantilevering of the wire end portions from the winding around the individual teeth to the joining location at the winding terminal tab causes natural vibrations of the wire end portions in the operating frequency range of the electric machine and/or of an internal combustion engine of a vehicle. The wire end portions are accordingly subject to a high-frequency mechanical alternating stress, which can lead to a fatigue failure of the wire ends at the joining location and, therefore, to wire breakage. The advantage of the invention consists in that the free wire length can be shortened because of the clamping of the wire end portions so that the natural vibration of the wire end portions is shifted outside of the operating frequency range. Accordingly, the risk of wire breakage can be appreciably reduced or eliminated in a simple and cost-effective manner so that an outage of the electric machine can be prevented and operating reliability can be increased.

In a particular implementation, it is provided that the free wire length of the wire end portion is shortened such that a natural frequency of the wire end portion is shifted outside of a frequency range of an operating frequency of the electric machine or of an internal combustion engine that is likewise provided in a vehicle powertrain. In other words, the wire end portion has a natural frequency lying outside of the operating frequency range during operation of the electric machine and/or of an internal combustion engine, preferably between the joining location and the clamping location.

The wire end portion preferably has, particularly between the joining location and the clamping location, a natural frequency of more than 3000 Hz, preferably more than 3500 Hz, especially more than 4000 Hz. By shifting the natural frequency outside of the operating frequency range, the wire end portion, particularly in the region of the joining location, can be prevented from being excited to vibration.

In a specific implementation, it is provided that the clamping location is arranged at more than 40% and less than 60% of the free wire length of the wire end portion. The clamping location is preferably essentially at 50% of the free wire length or one half of the wire length of the wire end portion. In concrete terms, this means that the natural frequency or the natural mode of the wire end portion is doubled when the free wire length is halved. Accordingly, depending on the arrangement of the clamping location, the natural frequency of the wire end portion can be selectively influenced in a simple manner.

In a specific aspect, it is provided that the wire end portion exits the winding of the single tooth coil at a winding outlet, the free wire length being measured from the free wire end to the winding outlet. Accordingly, the clamping location is arranged between the free wire end and the winding outlet. In other words, the clamping location is arranged at least approximately centrally between the free wire end and the winding outlet. In particular, by “winding outlet” is meant that portion of the coil winding at which the winding wire enters or exits the winding. In other words, the winding outlet represents the direct start or the direct end of the coil winding. In particular, the wire end portion is, at least once, deflected opposite the coil winding direction and/or shaped transverse to the coil winding direction. The winding outlet is particularly preferably located at a radial inner side of the stator in case of a radially outer winding terminal tab and at a radial outer side of the stator in case of a radially inner winding terminal tab.

In a further concrete configuration, it is provided that the winding end portion is cantilevered in radial direction with respect to the main axis from the winding outlet to the clamping location and is cantilevered in axial direction with respect to the main axis from the clamping location to the joining location. In other words, the wire end portion is fixed only at the winding outlet, the clamping location and the joining location. Therefore, simply stated, the winding outlet, the clamping location and the joining location, respectively, form a vibrational node, and the wire end portion forms a vibrational anti-node between the vibrational node and in the cantilevering region, respectively. In principle, the distance between the winding outlet and the clamping location may equal the distance between the clamping location and the joining location. Alternatively, the distance between the clamping location and winding outlet is different and/or greater than the distance between the clamping location and the joining location. In particular, the wire end portion after the clamping location is deformed by at least, or by exactly, 90° in direction of the winding terminal tab. Accordingly, it is suggested that the wire end portions be fixed so as to simultaneously allow a free movement, particularly a free oscillation, between the fixating points.

In a particular implementation, it is provided that the winding outlet is arranged radially inward and the winding terminal tab is arranged radially outward, and the clamping location is arranged at the radially outer limit portion. In particular, the connector ring arrangement has at least one, or exactly one, supporting portion for each winding area, this supporting portion being supported and/or supportable at the radially outer limit portion. Accordingly, the clamping of the wire end portion is preferably carried out in axial direction between the radially outer limit portion and the radially outer supporting portion. In particular, this means that the supporting portion is supported and/or supportable in radial direction directly at the radially outer limit portion and, at the same time, is supported in axial direction via the wire end portion at the radially outer limit portion. Accordingly, the wire end portion is preferably fixed at the clamping location in a frictionally engaging manner in all spatial directions. This makes possible a reliable clamping of the wire end portions.

In a further aspect, it is provided that the wire end portion is clampingly fixed at the clamping location at least in axial direction by an interference fit between the limit portion and the supporting portion. In particular, the connector ring arrangement is fixed in an axial position in axial direction via the axial connections, and the wire end portion is fixed in the axial position with the interference fit or press fit between the limit portion and the supporting portion. To this end, an axial distance between the limit portion and the supporting portion is less than a wire diameter of the wire end portion at least in the region of the clamping location. In order to produce the interference fit, the wire end portion is installed over the limit portion in direction of the winding terminal tab, and the connector ring arrangement is subsequently mounted and secured in its axial position. The connector ring arrangement is acted upon by an axial preloading force in order to produce the interference fit during the production of the axial connection and/or to apply the clamping force to the wire end portion at the clamping location in direction of the limit portion. This enables a particularly simple and reliable securing of the wire end portion at the clamping location.

In a further development, it is provided that optionally either the limit portion or the supporting portion has a wire guide aperture which is formed and/or suitable for guiding the wire end portion. The wire end portion is received in a positive engagement at least in circumferential direction and/or tangential direction with respect to the main axis in the wire guide aperture. The wire guide aperture is preferably formed as an axially open cutout in which the wire end portion contacts axially and/or tangentially. For example, the wire guide aperture can be formed as a half-hole and/or with a snap contour. Alternatively, the wire guide aperture can also be formed as an opening or a borehole through which the wire end portion is guided. Because the wire end portion is received in the wire guide aperture in a positive engagement, slippage of the wire end portion between the limit portion and supporting portion can be prevented so that a particularly reliable fixing of the wire end portion can be realized.

In a particular configuration, it is provided that the wire guide aperture is formed as a V-shaped or U-shaped guide groove. Due to the V-shaped or U-shaped guide groove, the wire end portion can be fixed in the wire guide aperture free from play. The V-shaped or U-shaped guide groove is preferably open in axial direction so that the wire end portion can be inserted into the wire guide aperture in a simple manner. A particularly simple installation of the wire end portions is made possible in this way.

In a further aspect, it is provided that the wire end portion is bondingly connected to the limit portion and/or the supporting portion at the clamping location. In particular, the wire end portion can be bondingly connected to the limit portion and/or the supporting portion at the clamping location by gluing, painting or the like. The wire end portion is preferably bondingly fixed at least in the wire guide aperture. In this way, the wire end portion is additionally fixed at the clamping location such that a detachment of the wire end portion at the clamping location, for example, due to vibrations and/or friction, is appreciably reduced.

In a further development, it is provided that the other limit portion has a wire deflection contour which is formed and/or suitable for deflecting the wire end portion. The wire end portion is deflected in direction of the clamping location at a deflecting location via the wire deflection contour. In particular, the winding outlet is arranged adjacent to and/or in the immediate vicinity of the deflecting portion. The wire end portion is preferably deflected at the deflecting portion at least once or exactly once. The wire end portion is preferably deflected at the deflecting location by more than 90°, preferably by 180°. The wire deflection contour serves on the one hand to deflect the wire in direction of the opposite limit portion and, on the other hand, brings about a strain relief in the winding wire at the winding outlet. The wire deflection contour may be formed, for example, by a neck, projection, groove or the like at the limit portion. In particular, a further vibrational node is accordingly defined by the deflecting location. Therefore, a particularly reliable installation of the wire end portion is ensured from the winding outlet to the winding terminal tab. Further, the free wire length, particularly between the winding outlet and the clamping location, can be shortened further by the wire deflection contour.

In a particular aspect, it is provided that the connector ring arrangement has a plurality of, preferably exactly three, busbars, at which at least one, or a plurality, of the winding terminal tabs is formed in each instance. The connector ring arrangement has an insulation body in which the busbars are arranged to be electrically insulated from one another, the supporting portion being formed directly at the insulation body. In particular, the busbars are formed as annular rails, particularly formed from a strip-shaped or plate-shaped copper semi-finished product. The busbars are preferably arranged inside the insulation body one above the other coaxially and/or axially with respect to the main axis. When the electric machine is configured as a three-phase machine, the connector ring arrangement has exactly three of the busbars to which current is applied out of phase by 120° in each instance. The insulation body and the supporting portion are preferably produced from a common material portion, preferably a common plastic injection molding. This enables a particularly stable construction and a simple, cost-effective manufacture of the supporting portion.

In a further implementation, it is provided that a plurality of the winding bodies have at least one, or exactly one, fastening portion in each instance and the busbar arrangement, particularly the insulation body, has a plurality of fastening receptacles in each instance, the fastening portions being fixed in axial direction partially in the respective associated fastening receptacle to form an axial connection. In particular, the fastening portions are fixed in the respective fastening receptacle at least in axial direction in a positively engaging and/or frictionally engaging and/or bondingly engaging manner. In principle, the fastening portions can be formed as axially oriented threaded bolts which are guided through the fastening receptacles and fixed at the ends in the fastening receptacle via a screw nut in each instance. However, the fastening portions are preferably formed in each instance as pins which are formed directly at the insulation body and which are guided through the respective fastening receptacle and fixed in the occupied axial position by a subsequent heat staking process or other connection technique. Particularly after the axial connection is produced, the fastening portions have axial stops which are operative at both sides and between which the connector ring arrangement, preferably the insulation body, is fixed free from play at least in axial direction. In particular, every winding body has in each instance at least one, preferably two, of the fastening portions, a fastening portion being formed in each instance at one of the limit portions. Accordingly, a particularly simple and economical connection between winding body and connector ring arrangement is suggested, wherein a permanent fixing of the wire end portions at the clamping locations can be ensured by the axial connection.

In a further particular implementation, it is provided that each of the single tooth coils has, in each instance, exactly two of the wire end portions, the one wire end portion forming a winding start and the other wire end portion forming a winding end. The two wire end portions are preferably connected to one of the winding terminal tabs, respectively, via a joining location in each instance and are clampingly fixed in each instance between the limit portion and the supporting portion at a clamping location in each instance. To this end, the limit portion and/or the supporting portion preferably have exactly two wire guide apertures.

A further subject matter is directed to an electric machine with a rotor having a stator such as that described in the preceding. In particular, the electric machine is configured and/or suitable for generating an electric drive torque of a vehicle, preferably a tractive torque.

For example, the electric machine is formed as a traction machine. The electric machine may be integrated in an electric powertrain, preferably an electric axle. The electric powertrain can be purely electrical or can be a hybrid powertrain. The electric machine is preferably formed as an inrunner. In particular, the electric machine is fitted to a dual clutch transmission.

### BRIEF DESCRIPTION OF THE DRAWINGS

Further features, advantages and effects of the invention will be apparent from the following description of preferred embodiment examples of the invention. The drawings show:

FIG. 1 is a schematic sectional view of an electric machine;

FIG. 2 is a perspective view of a stator of the electric machine from FIG. 1;

FIG. 3 is a detailed sectional view of the stator from FIG. 2;

FIG. 4 is a radial detail view of the stator from FIG. 2.

### DETAILED DESCRIPTION OF THE PRESENTLY PREFERRED EMBODIMENTS

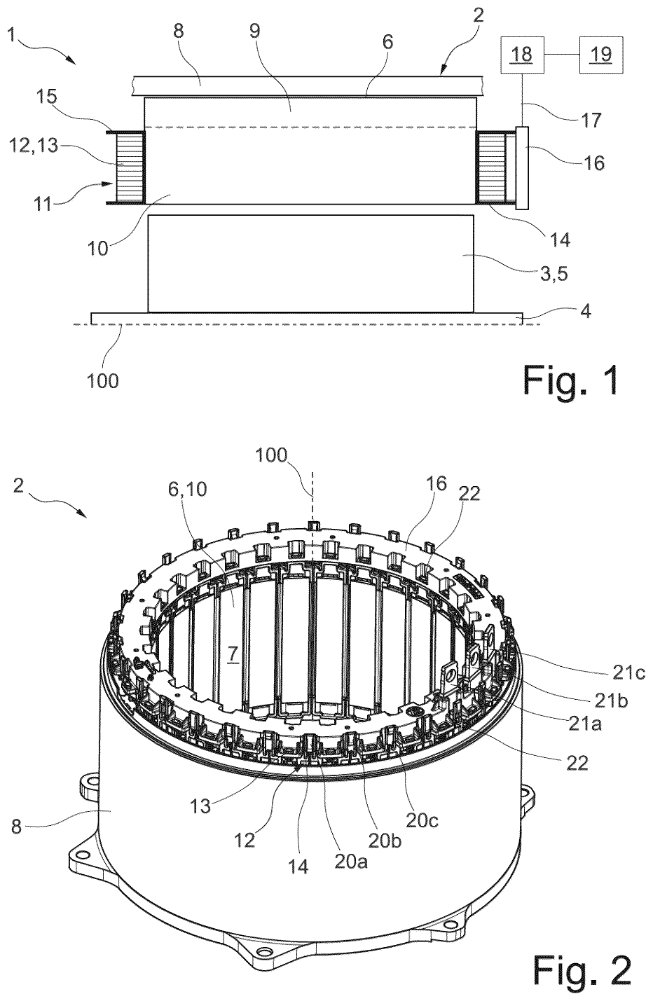

FIG. 1 schematically shows an electric machine 1 formed as a three-phase machine, particularly an inrunner-type permanently excited electric synchronous machine. The electric machine 1 may be formed as a traction drive in a powertrain of a hybrid or electric vehicle.

The electric machine 1 has a stator 2 and a rotor 3 which is arranged radially inward of the stator 2 and connected to a rotor shaft 4 so as to be fixed with respect to rotation relative to it, the rotor shaft 4 being mounted so as to be rotatable around a main axis 100. For example, the rotor 3 comprises a rotor lamination stack 5 in which are arranged a plurality of permanent magnets, not shown, spaced apart circumferentially.

The stator 2 has an annular stator body 6 that extends around the main axis 100 and which is constructed so as to be segmented in circumferential direction and combines through a plurality of identical stator segments 7 to form a closed ring as is shown in FIG. 2. The main axis 100 accordingly forms the central axis of the stator 2 at the same time. For example, the stator segments 7 can be constructed as lamination stacks. In its proper installation situation, the stator body 6 is inserted in a cylindrical stator support 8 so as to be fixed with respect to rotation relative to it, this stator support 8 forming an outer housing or an intermediate housing of the electric machine 1, for example.

The stator body 6 has an annular stator yoke 9 that contacts the stator support 8 and at which radially inner individual teeth 10 extend. The individual teeth 10 are outfitted, respectively, with a single tooth coil 12 to form a stator winding 11. The single tooth coils 12 are formed in each instance by a winding wire 13, for example, a round wire, which is wound by two winding bodies 14, 15 and secured against slippage. The winding bodies 14, 15 are formed, for example, from a heat-resistant plastic.

The single tooth coils 12 are associated with electrically discrete strands of a connector ring arrangement 16 via which the single tooth coils 12 are interconnected with one another in a predetermined manner, for example, in a delta circuit. The connector ring arrangement 16 is further connected via a power connection 17 to power electronics 18 and to an electric energy source 19 which can apply current of variable phase and amplitude to the stator winding 11 for operating the electric machine 1.

As is shown in FIG. 2, the connector ring arrangement 16 is formed annularly and has, in each instance, one winding terminal tab 20a, 20b, 20c for each single tooth coil 12 via which the winding wires 13 are electrically contacted with the connector ring arrangement 16. The winding terminal tabs 20a, 20b, 20c are arranged at a radial outer side of the connector ring arrangement 16 and are uniformly spaced apart in circumferential direction.

To form the power connection 17, the connector ring arrangement 16 further has three power connection tabs 21a, 21b, 21c via which the connector ring arrangement 16 is electrically connectable to the power electronics 18. In case of a three-phase machine, the stator winding 11 has three phases, a power connection tab 21a, 21b, 21c being provided for each phase.

The connector ring arrangement 16 is arranged coaxial to the main axis 100 and is secured to the winding bodies 14 at an axial end face of the stator 2 in axial direction with respect to the main axis 100 via a plurality of axial connections 22. For example, the connector ring arrangement 16 is secured to the winding bodies 14 non-detachably and free from play via the axial connections 22.

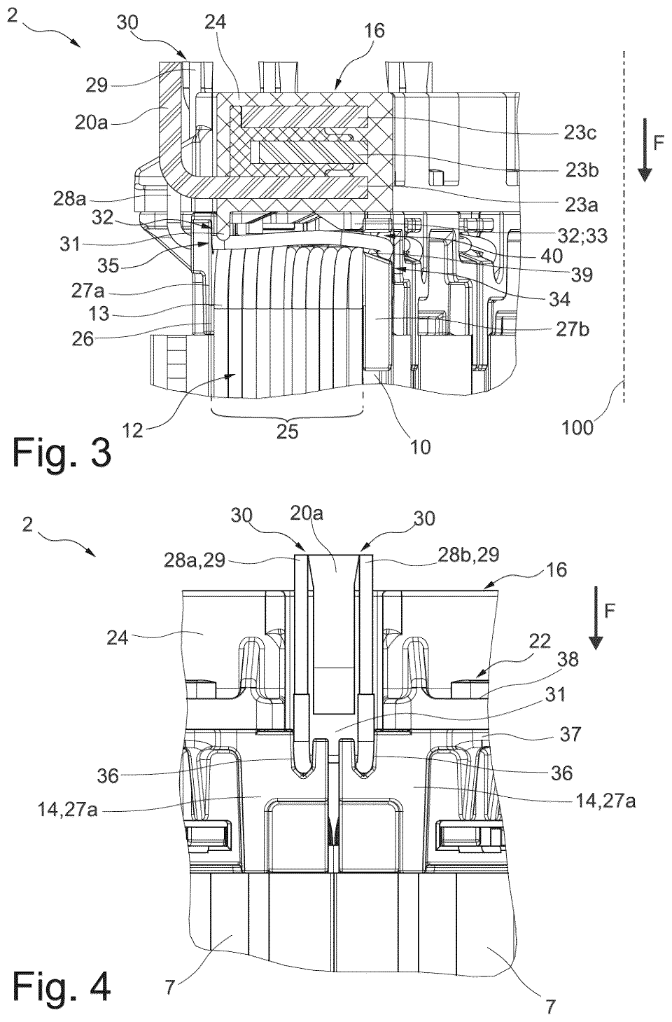

As will be apparent from FIG. 3, the connector ring arrangement 16 has three busbars 23a, 23b, 23c which are embedded in an insulation body 24 so as to be electrically insulated from one another. The busbars 23a, 23b, 23c are produced as annular disks, for example, from a copper semi-finished product, particularly a copper plate or a copper sheet, by punching and shaping processes. The busbars 23a, 23b, 23c are arranged coaxial to the main axis 100 and axially one above the other. Each busbar 23a, 23b, 23c has the associated winding terminal tabs 20a, 20b, 20c and the associated power connection tab 21a, 21b, 21c. The connector ring arrangement 16 is formed in the present case as a metal-plastic composite element in which the busbars 23a, 23b, 23c, with the exception of the winding terminal tabs 20a, 20b, 20c and the power connection tabs 21a, 21b, 21c, are overmolded with plastic to form the insulation body 24.

The winding bodies 14, 15 have, in each instance, a winding area 25 in which the winding wire 13 is wound at the respective individual tooth 10 to form the single tooth coil 12. The winding area 25 is formed by a base portion 26 contacting the individual tooth 10 at the front side and two limit portions 27a, 27b, which are spaced apart in axial direction and limit the winding area 25 in radial direction.

The single tooth coils 12 have, in each instance, two wire end portions 28a, 28b for forming a winding start and a winding end which are bondingly joined, respectively, with the associated winding terminal tab 20a, 20b, 20c by their free wire end 29 at a joining location 30. For example, the wire ends 29 are welded to the respective winding terminal tab 20a, 20b, 20c at the joining location 30. For interconnection, the two wire end portions 28a, 28b are connected, respectively, to the winding terminal tabs 20a, 20b, 20c immediately adjacent to one another by two single tooth coils 12 which are adjacent to one another in circumferential direction.

The connector ring arrangement 16 has at least one supporting portion 31 that faces the winding areas 25 and via which the connector ring arrangement 16 is supported and/or supportable in radial direction at the radially outer limit portions 27a of the winding bodies 14 to form a radial connection 32. The connector ring arrangement 16 further has at least one further supporting portion 33 via which the connector ring arrangement 16 is supported and/or supportable in radial opposite direction at the radially inner limit portions 27b of the winding bodies 14 to form the radial connection 32. The supporting portions 31, 33 are arranged radially inside of the winding area 25. The supporting portions 31, 33 are formed integrally, e.g., produced from a common plastic injection molding, at the underside of the insulation body 24 as two respective circumferential or interrupted axial projections.

The two wire end portions 28a, 28b exit from the winding area 25 at a radial inner side at a winding outlet 34. The wire end portions 28a, 28b are usually cantilevered until the joining location 30 and are accordingly characterized by a correspondingly large free wire length. During operation of the electric machine 1, a natural vibration of the wire end portions 28a, 28b can develop in the operating frequency range which can lead to a wire malfunction as a result of a fatigue failure of the copper material at the joining location 30. For this reason, the two wire end portions 28a, 28b are clampingly fixed, respectively, between the outer limit portion 27a and the outer supporting portion 31 at a clamping location 35 in each instance in order to shorten or halve the free wire length of the wire end portions 28a, 28b. The clamping location 35 is preferably arranged at approximately 50% of the free length of the wire between the joining location 30 and the winding outlet 34.

As is shown in FIG. 4, the radially outer limit portions 27a have a wire guide aperture 36 in each instance via which the wire end portions 28a, 28b are guided. The wire guide apertures 36 are formed as V-shaped insertion grooves in which the wire end portions 28a, 28b are axially inserted and held in a positively engaging and/or play-free manner in circumferential direction. For clampingly fixing the wire end portions 28a, 28b, the latter are arranged between the limit portion 27a and the supporting portion 31 by a press fit. To this end, an axial distance between limit portion 27a and supporting portion 31 in the area of the wire guide apertures 36 is smaller than a wire diameter of the winding wire 13.

In order to apply a clamping force F to the wire end portions 28a, 28b in axial direction with respect to the main axis 100, the connector ring arrangement 16 is fixed to be free from play at the winding bodies 14 via the axial connections 22. To this end, the two limit portions 27a, 27b have, in each instance, a fastening portion 37. A plurality of radially inner and radially outer fastening receptacles 38 which are distributed in circumferential direction are formed at the insulation body 24 to receive a fastening portion 37 in each instance.

The fastening receptacles 38 are formed as axial openings and the fastening portions 37 are formed as axially projecting pins which are guided through the respective fastening receptacle 38 and heat-staked at the ends. For example, the connector ring arrangement 16 can be acted upon by the clamping force F during the heat staking in order to clamp the wire end portions 28a, 28b in the respective wire guide aperture 36 via the supporting portions 31. For example, after the heat staking, the fastening portions 37 can form axial stops which are effective axially at both sides and between which the connector ring arrangement 16, particularly the insulation body 24, is secured free from play at least in axial direction in order to permanently maintain the clamping force F.

As is shown in FIG. 3, the winding bodies 14 have a wire deflection contour 39 in each instance at the radially inner limit portion 27b, and the wire end portions 28a, 28b are deflected axially in direction of the clamping location 35 after the winding outlet 34 at a deflecting location 40 via the wire deflection contour 39. The wire deflection contour 39 is formed, for example, by a deflecting groove formed at the radially inner limit portion 27b and via which the wire end portions 28a, 28b are deflected at least once and captively held in axial direction.

Accordingly, the wire end portions 28a, 28b cantilever between the deflecting location 40 and the clamping location 35 in radial direction with respect to the main axis 100 and cantilever between the clamping location 35 and the joining location 30 in axial direction with respect to the main axis 100. The wire end portions 28a, 28b are deformed by their wire ends 29 after the clamping location 35 in axial direction in direction of the winding terminal tabs 20a, 20b, 20c. The clamping location 35 is arranged approximately centrally between the joining location 30 and the deflecting location 40.

As is shown in FIG. 4, two adjacent wire ends 29 of two single tooth coils 12 which are adjacent in circumferential direction are connected to a winding terminal tab 20a, 20b, 20c to realize a delta connection. Accordingly, two wire end portions 28a, 28b are associated in each instance with one winding terminal tab 20a, 20b, 20c, which wire end portions 28a, 28b are positioned adjacent to the winding terminal tab 20a, 20b, 20c in circumferential direction. The winding terminal tabs 20a, 20b, 20c and the wire ends 29 are oriented parallel to one another. The winding terminal tabs 20a, 20b, 20c have a V-shaped widening.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A stator for an electric machine with a stator body which is formed around a main axis, comprising:
a plurality of radially oriented individual teeth;
a polyphase stator winding having a plurality of single tooth coils formed from a winding wire, wherein a single tooth coil is arranged in each instance at one of the individual teeth;
a plurality of winding bodies, wherein each winding body has a winding area for the single tooth coil formed by a base portion contacting one of the individual teeth by its front side and two limit portions which radially limit the winding area and are connected to the base portion;
a connector ring arrangement configured to interconnect the single tooth coils, which is secured to the plurality of winding bodies at an axial front side of the stator, wherein the connector ring arrangement has at least one supporting portion which faces the winding areas and via which the connector ring arrangement is supported at at least one of the limit portions in radial direction to form a radial connection;
a plurality of winding terminal tabs of the connector ring arrangement configured to connect the single tooth coils; and
at least one wire end portion of the winding wires is bondingly joined at an end thereof by its free wire end to an associated winding terminal tab at a joining location,
wherein the at least one wire end portion are clampingly fixed between one of the limit portions and a respective supporting portion at a clamping location in to shorten a free wire length of the wire end portion.

2. The stator according to claim 1, wherein the free wire length of the wire end portion is shortened such that a natural frequency of the wire end portion is shifted outside of a frequency range of an operating frequency of the electric machine.

3. The stator according to claim 1, wherein the clamping location is arranged at more than 40% and less than 60% of the free wire length of the wire end portion.

4. The stator according to claim 3,
wherein the wire end portion exits from the winding of the single tooth coil at a winding outlet, and
wherein the free wire length is measured from the free wire end to the winding outlet.

5. The stator according to claim 4, wherein the winding end portion is cantilevered in radial direction with respect to the main axis from the winding outlet to the clamping location and is cantilevered in axial direction with respect to the main axis from the clamping location to the joining location.

6. The stator according to claim 4,
wherein the winding outlet is arranged radially inward and the winding terminal tab is arranged radially outward, and
wherein the clamping location is arranged at a radially outer limit portion of the two limit portions.

7. The stator according to claim 1, wherein the wire end portion is clampingly fixed at the clamping location at least in axial direction by an interference fit between the limit portion and the supporting portion.

8. The stator according to claim 1,
wherein one of the limit portion and the supporting portion has a wire guide aperture configured to guide the wire end portion, and
wherein the wire end portion is received in a positive engagement at least in circumferential direction in the wire guide aperture.

9. The stator according to claim 8, wherein the wire guide aperture is a V-shaped or U-shaped guide groove.

10. The stator according to claim 1, wherein the wire end portion is bondingly connected to the limit portion and/or the supporting portion at the clamping location.

11. The stator according to claim 1,
wherein one of the two limit portions has a wire deflection contour configured to deflect the wire end portion, and
wherein the wire end portion is deflected in direction of the clamping location at a deflecting location via the wire deflection contour.

12. The stator according to claim 1,
wherein the connector ring arrangement has an insulation body in which at least one busbar having the winding terminal tabs is arranged, and
wherein the supporting portion is formed directly at the insulation body.

13. The stator according to claim 1,
wherein each of the plurality of the winding bodies have at least one fastening portion and the connector ring arrangement has a plurality of fastening receptacles, and
wherein the fastening portions are fixed in axial direction partially in a respective associated fastening receptacle to form an axial connection.

14. The stator according to claim 1,
wherein each of the single tooth coils has exactly two of the wire end portions,
wherein a first of the one wire end portion forms a winding start and a second of the one wire end portion forms a winding end, and
wherein the two wire end portions are joined with a winding terminal tab at a joining location and are clampingly fixed between the limit portion and the supporting portion at a clamping location in each instance.

15. An electric machine comprising:
a rotor; and
a stator, comprising:
a plurality of radially oriented individual teeth;
a polyphase stator winding having a plurality of single tooth coils formed from a winding wire, wherein a single tooth coil is arranged in each instance at one of the individual teeth;
a plurality of winding bodies, wherein each winding body has a winding area for the single tooth coil formed by a base portion contacting one of the individual teeth by its front side and two limit portions which radially limit the winding area and are connected to the base portion;
a connector ring arrangement configured to interconnect the single tooth coils, which is secured to the plurality of winding bodies at an axial front side of the stator, wherein the connector ring arrangement has at least one supporting portion which faces the winding areas and via which the connector ring arrangement is supported at at least one of the limit portions in radial direction to form a radial connection;
a plurality of winding terminal tabs of the connector ring arrangement configured to connect the single tooth coils; and
at least one wire end portion of the winding wires is bondingly joined at an end thereof by its free wire end to an associated winding terminal tab at a joining location,
wherein the at least one wire end portion are clampingly fixed between one of the limit portions and a respective supporting portion at a clamping location in to shorten a free wire length of the wire end portion.
